(19) United States
(12) Patent Application Publication
(10) Pub. No.: US 2012/0312020 A1
(43) Pub. Date: Dec. 13, 2012

(54) Regeneration of Capture Medium

(76) Inventors: Scott Alexander Hume, Renfrew (GB); Agnieszka Magdalena Kuczynska, Renfrew (GB)

(21) Appl. No.: 13/516,167

(22) PCT Filed: Dec. 17, 2010
(86) PCT No.: PCT/GB2010/052125

§ 371 Date: Jul. 25, 2012

(30) Foreign Application Priority Data
Dec. 18, 2009 (GB) 0922142.5

(51) Int. Cl. B01D 19/00; B01D 53/14; F01K 19/00; F01K 13/00

(52) U.S. Cl. 60/657; 202/185.1; 96/201; 203/91; 95/173; 60/670

(57) ABSTRACT

An apparatus and method for the regeneration of captured gas rich capture medium such as an absorption solution and the recovery of absorbed gas therefrom, an apparatus and method for the removal and recovery of a target gas from a gas stream, and the use of the same for post combustion carbon capture on a thermal power plant are described. The apparatus and method make use of a regenerative heating process. The apparatus and method are distinctly characterized by the use of a heat pump to utilize low grade heat, for example from elsewhere in the process, as a source of thermal energy for the heating process.

The invention relates to a method and apparatus for the regeneration of a capture medium of the type used in an industrial process for the removal of constituents from a gas phase by absorption/adsorption and like processes. The invention for example relates to the regeneration of a medium used for the removal and capture of acid gases such as carbon dioxide from a gas phase through a solution absorption and regeneration processes. The invention relates particularly to the regeneration of absorption solution during the regeneration process. The invention is particularly suitable for application in an aqueous absorption and regeneration system for removing CO₂ from the flue gases of thermal power plants fired by carbonaceous fossil fuels, both as new build and for retrofitting into existing capture systems.

Most of the energy used in the world today is derived from the combustion of fossil fuels, such as coal, oil, and natural gas. Post-combustion carbon capture (PCC) is a means of mitigating the effects of fossil fuel combustion emissions by capturing CO₂ from large sources of emission such as thermal power plants which use fossil fuel combustion as the power source. The CO₂ is not vented to atmosphere but is removed from flue gases by a suitable absorber and stored away from the atmosphere. Other industrial processes where similar principles might be applicable to capture post-process CO₂ might include removal of CO₂ generated in a process cycle, for example removal of CO₂ from the process flow during production of ammonia, removal of CO₂ from a natural gas supply etc.

It is known that CO₂ can be separated from a gas phase, for example being the flue gas of a thermal power plant, by means of absorption by passing the gas through a column where the gas flows in an opposite direction to a capture medium in the form of an absorbent in liquid phase, typically in aqueous solution. Such a process is sometimes referred to as wet scrubbing. A well known absorbent reagent comprises one or more amines in water.

Gas is passed through the absorption solution under conditions of pressure and temperature optimised for removal of substantially all the carbon dioxide into the absorption solution. The purified gas emerges at the top of the absorption column and is then directed for further processing as necessary. The absorption solution rich in CO₂ is drawn off at the foot of the absorption column and subjected to a stripping process to remove the CO₂ and regenerate the absorption solution.

To effect this the CO₂ rich solution is passed onwards to a suitable apparatus for recovery of the gas and regeneration of the solution. Typically this process involves regenerative heating of the solution, for example through successive cycles of reheating and for example by means of a reboiler. The CO₂ rich solution is for example introduced into a regeneration column, and maintained at high temperature, which may be at or near boiling point under pressure. The heat necessary for the reboiler is typically obtained when the system is used in association with a thermal power plant by supplying the reboiler with a proportion of the steam from the LP turbine system. At higher temperatures the solution will release the absorbed CO₂. Regenerated solution may be drawn off for reuse in the absorption column. Vapour containing the stripped CO₂ and also typically comprising water vapour and solvent vapour emerges at the top of the regeneration column and is passed through a condenser system which condenses the vapour and returns the liquids to the regeneration column. The released CO₂ may then be collected for example for sequestration. Solid media may also be considered where appropriate to the application where a target gas is selectively adsorbed/absorbed by a solid phase capture medium, whether formed as an active species on passive carrier or via a solid that is directly active. Some carbon capture systems based on amine or similar chemistry stabilise an active sorbent on solid carriers instead of in solution. Solid adsorbent capture systems based on the use of cyclic adsorption/desorption processes with immoblised amines or other CO₂-binding materials held on solid supports such as activated carbons, zeolites or other fine tailored alumina, silica, zirconia or their combinations are seen as a possible next generation carbon capture technology. Generally similar principles are likely to be applied to the regeneration of such solid capture media. References to an absorption solution by way of example will be thus understood as generally applicable to other capture media susceptible of regeneration to recover captured target gas in similar manner.

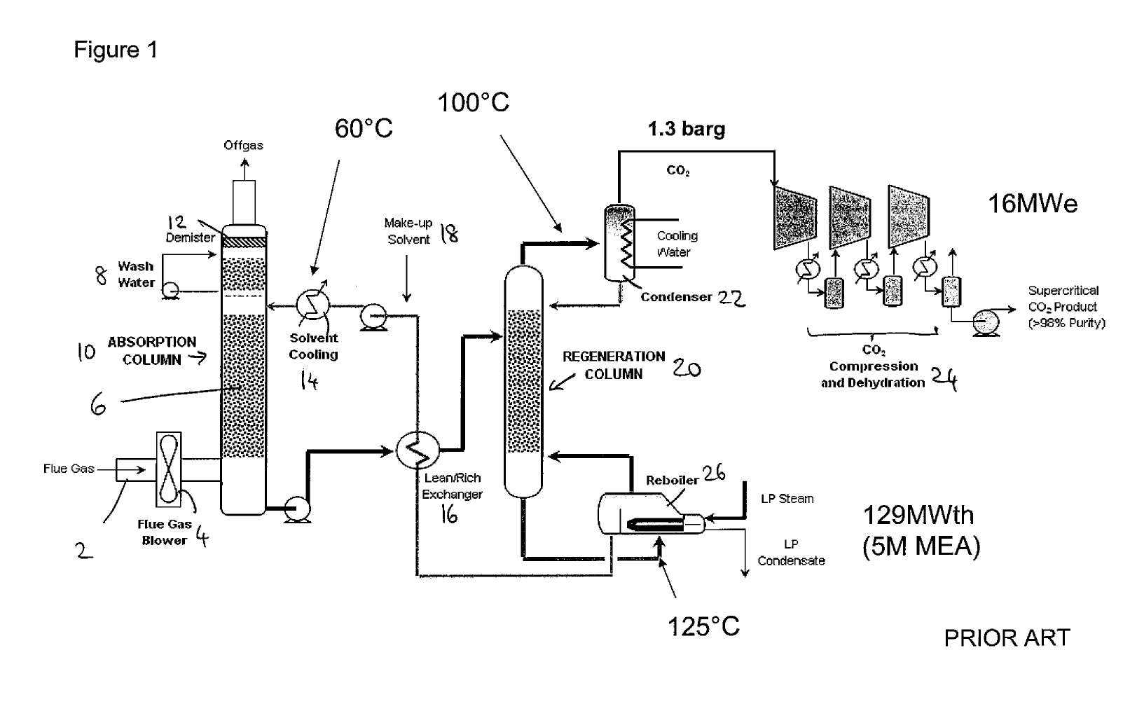

A schematic of a known absorption and recovery apparatus as above described is shown in FIG. 1.

A problem with the existing absorption and recovery process described above is that it can be very energy intensive. The energy requirement arises in large part because of the heat required for the reboiler. In application on a thermal power plant, the required reboiler heat can reduce net power production by as much as 15% or more.

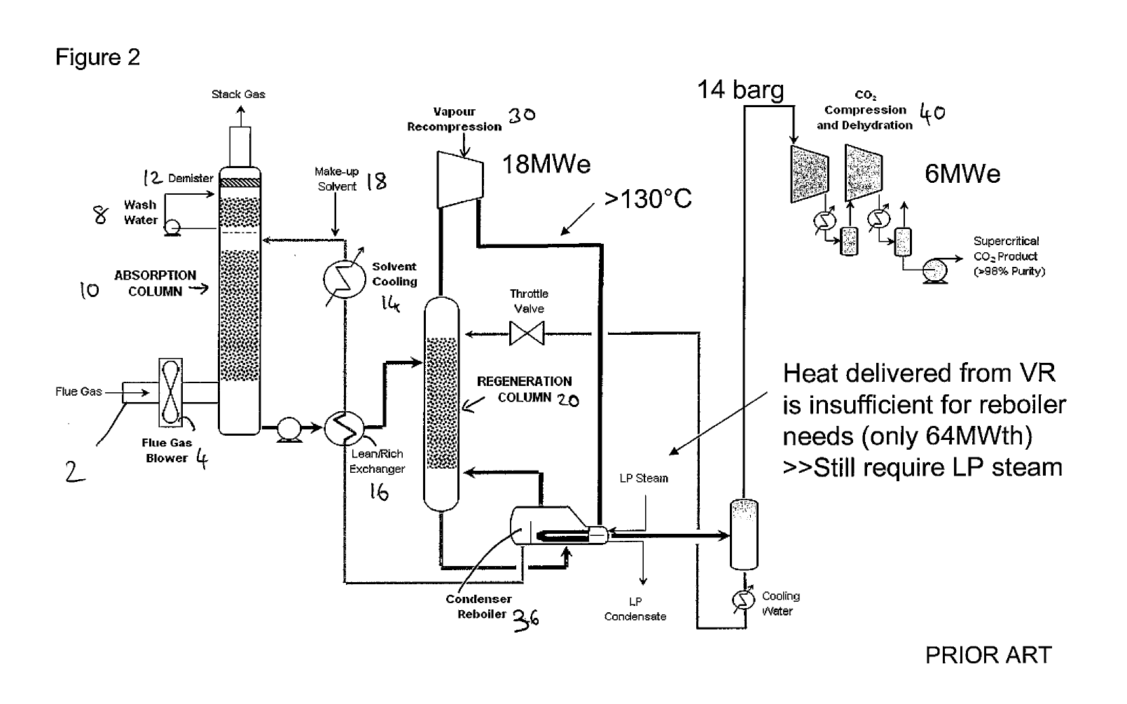

It is known to improve the energy efficiency of the process by making use of vapour recompression to recover useful heat from the vapour/CO₂ stream. The vapour/CO₂ stream from the regeneration column is compressed and then used to provide heat for the reboiler. A schematic of an absorption and recovery apparatus incorporating such a modification is shown in FIG. 2.

However, in a typical configuration in a thermal power plant the heat delivered from vapour recompression is insufficient for the total reboiler requirement. As can be seen in FIG. 2 the system still requires some LP steam to make up the deficiency.

In accordance with the invention in a first aspect there is provided an apparatus for the regeneration of a capture medium rich in a captured target gas such as an absorbed gas rich absorption solution and the recovery of absorbed gas therefrom comprising:

a containment structure defining a process volume;

a supply conduit to pass captured gas rich capture medium into the process volume;

condensing heating means fluidly connected to the process volume to heat the gas rich capture medium and thereby cause captured gas to dissociate into a gas rich vapour phase;

a vapour recompression system fluidly connected to the process volume to receive vapour output from the process volume and to compress the same;

a compressed vapour supply conduit to supply output compressed vapour to the heating means as a source of thermal energy therefor;

a secondary source of thermal energy for the heating means comprising at least one heat pump fluidly in communication with one or more sources of low grade heat so as to be driven in use to recover thermal energy from the source(s) of low grade heat and to supply the recovered thermal energy to the heating means as a further source of energy therefor.

The apparatus of the invention is thus an apparatus for the regeneration of capture medium and in the preferred case absorption solution, most of the features of which will be familiar from the prior art.

As will be understood, the apparatus of the invention comprises an apparatus for the regeneration of capture medium by removal of a target gas species previously associated therewith, for example having been previously associated therewith in a suitable capture apparatus in which a gas phase containing the target gas has been caused to flow through the capture medium. The capture medium may be any medium suitable for that purpose. The capture medium may be any medium with selective specificity to associate with a target gas, whether via physical or chemical absorption, adsorption or like processes, in particular to tend to associate at a first, lower process temperature and dissociate at a second, higher process temperature. The capture medium may thus be regenerated to recover captured target gas by heating.

The capture medium may be in any state, such as is in solid, fluidised solid or liquid state, that allows a gas phase containing the target gas to flow through it. The capture medium may comprise a material inherently able to associate with the target gas or may comprise a compound structure of an active ingredient so able to associate and a passive carrier.

In a preferred case the capture medium is for example an absorption solution from a wet scrubber. Many of the features of such systems will be familiar from the prior art. The invention is discussed below applied to a system for such an absorption solution but this is an example only of a possible system and capture medium to which the invention could be applied.

The containment structure defines a process volume which is for example an elongate column, for example disposed vertically. A solution comprising absorbent solvent which is rich in an absorbed target gas, for example from a suitable absorption column, is passed into the volume, for example towards the top of the regeneration column. The column preferably contains high surface area separation structures. Solution passing out of the volume, for example at the bottom of the column is, subject to a repeatedly cycled heating and for example reboiling process by the heating means in a manner which will be familiar. Thus, the heating means typically comprises a reboiler such as a condensing reboiler.

The result of this process is to cause the absorbed gas to tend to dissociate from the solution, and to result in the production of an absorbed gas rich vapour phase (for example further including water vapour, and solution vapour) which can be drawn from the process volume for example at the top of the column, and a lean regenerated solution which can be removed for reuse in an absorption system. Such an arrangement will be generally familiar from the prior art.

The invention is distinctly characterised in the two sources of thermal energy which are used to provide energy, and in the particular preferred case substantially all of the energy, necessary to drive the heating means.

First, the vapour stream rich in recovered formerly absorbed gas is subject to compression in a vapour recompression apparatus comprising one or more compressors. The heat recovered by this process is delivered to the heating means to supply some of its thermal energy requirement.

Such an arrangement alone is known. However, it is insufficient to meet the entire requirement of a typical reboiler. In prior art systems, a vapour recompression method can reduce the amount of LP steam required to provide energy for the reboiler, but cannot substitute for it. A substantial amount of LP steam energy is still required.

The invention is distinctly characterised in the way that the shortfall in energy is made up. At least in part, and preferably entirely in substitution to the supply of LP steam, one or more heat pumps are used to recover energy from source(s) of low grade heat.

The invention is thus distinctly characterised by the use, in combination, of a vapour recompression method and the recovery of energy from source(s) of low grade heat via one or more heat pumps, which together reduce the amount of LP steam required to provide energy for the reboiler or other heating means and in the preferred case eliminate the need to supply LP steam altogether.

As will be readily understood by those skilled in the art, references to low grade heat in the context of thermal power generation systems are references to heat which is effectively a waste product in that it cannot practically be used in the generation process, for example in that it cannot practically be used for the generation of steam. A low grade heat source might in particular comprise a fluid at a temperature above ambient but below 100° C. and/or a source of thermal energy which is capable of heating a suitable thermodynamic fluid to a temperature above ambient but below 100° C.

Sources of low grade heat may include, but do not necessarily require to be, sources of low grade heat recovered from elsewhere within the regeneration process and/or from elsewhere within a target gas absorption and regeneration process making use of a regeneration apparatus of the invention, for example including compressors, condensers or other coolers within the process stream. Sources of low grade heat supplied to heat pump may include without limitation one or more of: heat recovered from the cooling of regenerated absorption solution prior to its delivery for reuse; condensation of the gas stream delivered from the regeneration apparatus, for example to remove solvent and/or water vapour therefrom; stages of compression of the target gas prior to storage. Other sources of low grade heat might include sources from an associated thermal power plant or from another industrial process.

Making use of suitable source(s) of low grade heat via a heat pump in accordance with the invention provides an alternative means to supply at least some, preferably a major part of, and particularly preferably substantially all of, the thermal energy deficit which cannot be supplied by vapour recompression alone. This potentially substantially reduces, and in the preferred case essentially obviates, the need to use thermally useful steam, for example, LP steam, from the thermal power plant.

Thus, in the preferred case, the heating means, such as the reboiler, is not supplied with thermally useful steam and in particular is not supplied with LP steam. Rather, in the preferred case, the supply of thermal energy to the heating means consists solely of, in combination, the heat recovered by the vapour recompression system and the heat recovered by the at least one heat pump.

The heat pump is preferably driven from a source of electrical power, which may for instance be generated output from an associated thermal power plant. The compression apparatus may be driven from the same source of electrical power, or independently from another source of electrical power, or may be driven by other means. For example, steam turbine driven compressors could also be considered. This does not depart from the principle that there need be no supply of thermally useful steam as a source of heat for the heating means.

In a particularly preferred case, the concept assumes the use of only electrical power to drive both the vapour recompression process and the heat pump. There is no requirement for the supply of thermally useful steam from the power plant. Such a solution potentially makes a regeneration apparatus in accordance with the first aspect of the invention, and consequently a post combustion carbon capture incorporating such an apparatus, independent from the steam turbine cycle and avoids heat/mechanical integration issues which arise when a PCC system is dependent upon turbine steam.

The heat pump is preferably a compression heat pump in which the heat transfer means comprise means for the selective compression and expansion of a circulating thermodynamic fluid, and in particular a vapour-compression heat pump comprising means for the cyclical evaporation, compression and condensation of a circulating thermodynamic fluid. Thus, a thermodynamic fluid is circulated through an apparatus comprising an evaporator disposed such that the thermodynamic fluid is evaporated by a source of low grade heat to recover thermal energy therefrom, a compressor, and a condenser disposed to supply the recovered thermal energy to the heating means in familiar manner.

The concept has great potential for decoupling the carbon capture plant and the steam power plant electricity generation processes. That is, the plants can be kept separate except for the flue gas supply from the latter to the former. The steam and electric processes are kept entirely separate.

The heating means is for example a condenser reboiler as is familiar. Again as is familiar it is disposed to receive solution that has passed through a process volume, for example via an outlet towards the bottom of a column, and reboil the solution. The invention is distinctly characterised in that the energy for the reboiler is supplied at least in large part both by vapour recompression and from the heat pump. This may significantly reduce or eliminate the need for a stream from the LP turbine system. Thus, in the preferred case, the regeneration apparatus may be further distinguished by the absence of any steam supply from the LP turbine system.

The vapour recompression apparatus may comprise a single compressor. Optionally, a plurality of compressors may be provided, for example in series, to compress the vapour. The vapour is compressed for example to 2 to 20 bar or higher if necessary.

The apparatus conveniently incorporates a condenser to condense and recover solution vapour from the compressed vapour phase. Conduit means may be provided to feed recovered solution condensed from the vapour phase to any suitable point in the system and for example back into the containment structure.

The apparatus conveniently incorporates a condenser to condense and recover water vapour from the vapour phase. Conduit means may be provided to deliver the recovered water to any suitable point in the system.

The resultant output is a substantially pure target gas phase, for example substantially pure CO₂ gas phase, suitable for subsequent storage. In a more complete system, the apparatus may further comprise fluidly in series a conduit to deliver the gas phase produced by the condensing heating means via optional additional condensing cooling means, for example as above described, optionally via a dehydration apparatus, to a compression system for storage. In the preferred case, where the recovered gas is CO₂, such a system is known to produce greater than 98% purity CO₂ for storage.

Conveniently, such condensing cooling means and/or compression systems are additionally adapted to serve as sources of low grade heat for the heat pump.

The regeneration apparatus is in particular intended for and is preferably adapted for use with an absorption apparatus such as an absorption column suitable for absorbing a target gas from a source gas stream into a suitable capture medium such as an absorption solution, producing a target gas rich solution which may then be passed to the regeneration apparatus of the first aspect of the invention for regeneration of capture medium and recovery of absorbed target gas therefrom.

Preferably, at least one regeneration apparatus as above described is provided for use with, and for example in fluid series downstream of, at least one such absorption apparatus.

Thus, in a more complete second aspect of the invention, an apparatus for removal of a target gas from a source gas stream comprises an absorption apparatus fluidly upstream of a regeneration apparatus in accordance with the first aspect of the invention. The absorption apparatus in particular comprises a means to absorb a target gas from a source gas stream into a suitable capture medium such as an absorption solution and for example is a means to countercurrently flow an absorption solution and a source gas stream so as to cause the target gas to pass into and be absorbed by the absorption solution. That is to say, the absorption apparatus for example comprises an absorption column or wet scrubber column as will be familiar.

Such an absorption column may for example comprise a containment vessel, and for example a vertical containment vessel, containing multiple sections of structured packaging to maximise the surface area for mass transfer. The gas stream inlet means may be provided, for example towards the bottom of the column, to inlet a gas stream including a target gas. Solution supply means may be provided, for example towards the top of a column, to provide lean absorption solution thereto. The gas stream flows upwards through the column as the absorption solution flows countercurrently downwards. Target gas is absorbed into the absorption solution and a target gas rich absorption solution is drawn off, for example at the bottom of the column. A rich absorption solution outlet is preferably provided for this purpose.

The apparatus preferably comprises a rich absorption solution conduit linking the rich absorption solution outlet to a rich absorption solution inlet of the regeneration apparatus of the first aspect of the invention. The apparatus preferably further comprises a lean absorption solution conduit to pass regenerated lean absorption solution from the regeneration apparatus to an absorption solution inlet of the absorption apparatus. The lean absorption solution conduit may include solution cooling means to cool the regenerated solution from the higher temperature at which it leaves the reboiler to a lower temperature more suitable for the absorption process. Conveniently, such cooling means is additionally adapted to serve as a source of low grade heat for the heat pump.

The target gas is preferably an acid gas, and is especially CO₂. Preferred absorption solutions include aqueous solutions of suitable absorbent reagents. Systems for the recovery of CO₂ from a gas stream are well established, and suitable chemistries and absorbent reagents are well known. The solution may for example comprise one or more aqueous amines, for example including but not limited to monoethanolamines or methyl-diethanol-amines. However, the invention is not limited by chemistry, being applicable to any process where a gas rich absorption solution is regenerated thermally to recover the target gas and lean solution.

In a particularly convenient application of the invention, the source gas stream is flue gas from a combustion apparatus for the burning of carbonaceous fuels, such as flue gas from a thermal power plant.

It follows that in a more complete third aspect of the invention, there is provided a thermal power plant comprising a combustion means to burn carbonaceous fuel and generate steam, and a regeneration apparatus in accordance with the first aspect of the invention or a gas removal apparatus in accordance with the second aspect of the invention including such a regeneration apparatus.

The power plant may optionally additionally comprise a flue gas outlet fluidly connected to supply flue gas directly from the combustion apparatus as a source gas stream to a removal apparatus of the second aspect of the invention.

In accordance with the invention in a fourth aspect there is provided a method of regeneration of a capture medium rich in a captured target gas such as an absorption solution rich in absorbed gas and recovery of an absorbed gas therefrom comprising the steps of:

heating a target gas rich capture medium such as an absorption solution, in particular repeatedly, and in particular by reboiling, and thereby causing captured gas to dissociate into a gas rich vapour phase;

compressing the vapour phase and using the compressed vapour as a first source of thermal energy for heating the capture medium;

additionally providing at least one supply of low grade heat to a heat pump and using the heat pump output as a further source of thermal energy for heating the capture medium.

The method in particular comprises passing the gas rich capture medium such as an absorption solution through a regeneration apparatus as above described having a heating means to heat the gas rich capture medium such as an absorbent solution, in particular by reboiling, and thereby cause captured gas to dissociate into a gas rich vapour phase; wherein the compressed vapour is used to supply thermal energy to the heating means; and wherein

the resultant heat pump output is used by the heating means as a further source of thermal energy therefor.

Thus, as above described, low grade heat recovered by the heat pump is used as a source of recovered heat to supplement the thermal energy requirement of the heating means. The requirement to use LP steam can be reduced or eliminated.

In the preferred case the compressed vapour and the resultant heat pump output together consist essentially of the sole source of thermal energy for the heating means and there is no requirement to supply LP steam to the heating means.

Further stages of process will be understood by the description of the foregoing apparatus. In particular the gas regenerated by the foregoing method steps may be then be subject to condensation, for example to remove absorbent liquid vapour and/or water vapour, drying, compression/liquefaction stages, for example to pass on for onward storage. In a refinement of the method, low grade heat is recovered from the condensation process and/or from the compression/liquefaction process and is provided to the heat pump for use as a further source of thermal energy as above described.

The target gas for capture is for example an acid gas such as CO₂, which has for example being removed from a combustion gas stream such as a flue gas stream from a thermal power plant.

Thus, in accordance with a fifth aspect of the invention there is provided a method for the removal and recovery of a target gas from a gas stream which comprises the steps of:

capturing and for example absorbing a target gas from a source gas stream into a suitable capture medium such as an absorption solution by passing the source gas stream through lean capture medium so as to cause a target gas component of the gas stream to associate with the capture medium and for example be absorbed by the absorbent solution, for example by passing the gas stream through an absorbing apparatus comprising a means to countercurrently flow absorbent solution and gas;

drawing off the resultant target gas rich capture medium;

processing the target gas rich capture medium in accordance with the fourth aspect of the invention.

The gas stream is especially combustion flue gas, for example thermal power plant flue gas, the gas being especially CO₂ the method being especially in a preferred case a method of removal and recovery for sequestration of CO₂ from a flue gas stream such as a thermal power plant flue gas stream.

Such a method is generally familiar, and the subject of well established techniques, apparatus and chemistries. The distinct feature of the method of the present invention in accordance with all aspects is the use of a heat pump to recover thermal energy from various stages of the regeneration process and/or from other processes to reduce and potentially eliminate the need to use LP steam.

The invention will be now be described by way of example only with reference to FIGS. 1 to 3 of the accompanying drawings in which:

FIG. 1 is a simple schematic of a prior art absorption and regeneration system;

FIG. 2 is a simple schematic of an alternative prior art absorption and regeneration system including a vapour recompression capability;

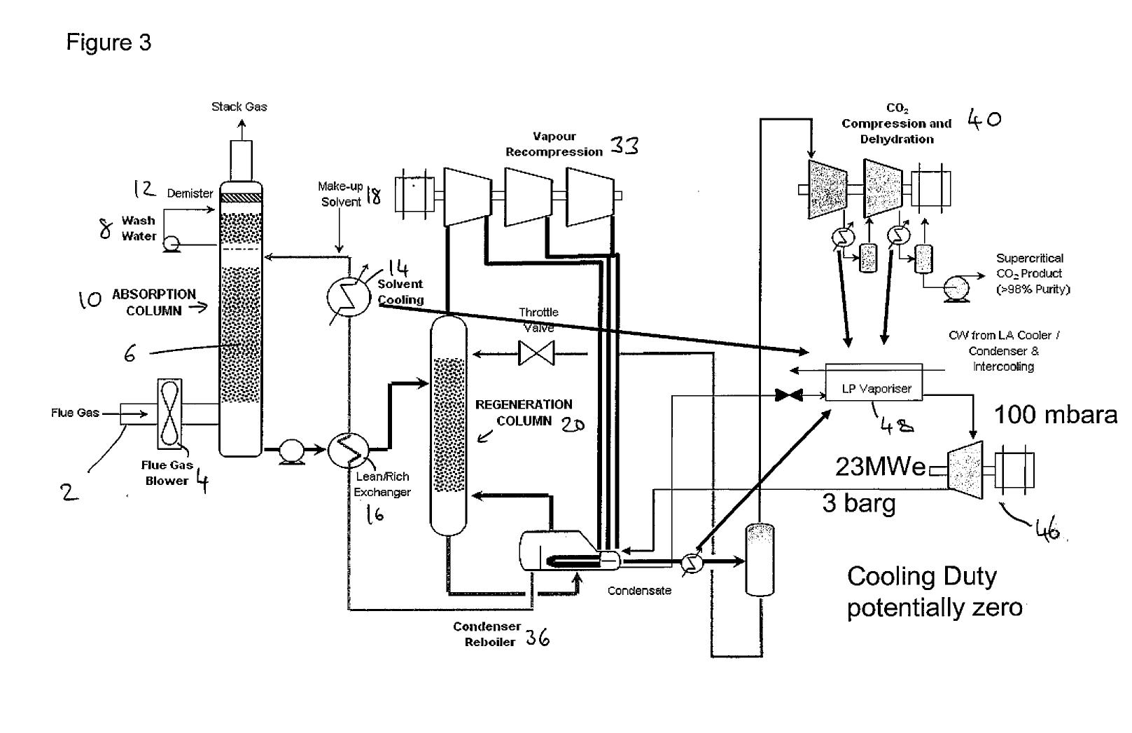

FIG. 3 is a simple schematic of an absorption and regeneration system embodying the principles of the invention.

Reference is made first to FIG. 1, which is a general schematic of a typical prior art system for the removal of CO₂ from flue gas via absorption, its recovery via regeneration, and its compression for sequestration.

Flue gas is supplied via a flue gas supply conduit 2 and flue gas blower 4 into the lower part of an absorption column 10. The absorption column is of any suitable design, and for example comprises a vessel containing structured packing adapted to maximise surface area for exchange between liquid and gas and absorption of the CO₂ by the absorption liquid. It may contain other structures such as washing structures, demister etc as is conventional.

Solvent is introduced to an upper part of the column, for example from a fresh supply source and/or as lean solvent regenerated from the regeneration part of the system described below, and flows under the action of gravity countercurrently to the rising flue gas within the column. As this flow takes place, CO₂ is absorbed into the solvent in familiar manner.

The scrubbed flue gas progresses upwards through a washing structure, again comprising structured packing through which water is supplied countercurrently via the wash water supply 8, and passes via demister 12 out of the top of the column for onward processing. The CO₂ rich solvent passes to an outlet at the foot of the column and is passed via a suitable conduit through a solvent cooling stage 14 and a lean/rich solvent exchanger 16 and introduced to a regeneration column 20. A make up supply 18 may be added at this point.

As the temperature of the rich solvent is elevated, CO₂ previously absorbed is released. This generates a vapour phase which is rich in CO₂, and which additionally comprises some solvent vapour. The vapour phase is passed through a condenser 22 and condensed solvent vapour returned to the regeneration column 10. The resultant output gas, rich in CO₂, is passed to a compression and dehydration system 24 and the resultant high purity CO₂ product may be processed, for example for sequestration. The lean solvent is circulated through a reboiler 26 which is heated by LP steam from an associated thermal power plant (not shown). The regenerated lean solvent may be returned to the absorption column 10 for reuse.

The system represented in FIG. 1 is conventionally known in the art. It represents an effective solution to the problem of removal of CO₂ from flue gases in a thermal power plant, but can be quite energy intensive. The use of LP steam to drive the reboiler can reduce the efficiency of the thermal power plant significantly, perhaps by 15% or more.

An arrangement to mitigate this inefficiency to some extent is illustrated in FIG. 2.

The general principles of the system illustrated schematically in FIG. 2 upstream of the regeneration column are identical to those of FIG. 1 and like reference numerals are used where applicable. The apparatus of FIG. 2 differs in the way that the vapour phase removed from the top of the column is further processed. The vapour phase is subject to a vapour recompression 30 and the compressed and consequently heated vapour phase is passed via a condenser reboiler 36 to provide some of the thermal energy required for the reboiling process. The compressed vapour phase is then passed via a condenser to remove solvent vapour which is returned to the regeneration column. The relatively pure CO₂ is then passed on to a further compression and dehydration system 40. However, since the CO₂ is already under higher pressure as a result of the vapour recompression process, the energy required for subsequent compression prior to storage is reduced.

Such a system in known to offer potential increased efficiency. The recovery of energy from the system via the vapour recompression process can significantly reduce the thermal energy required to drive the reboiler.

Although electrical energy is required to drive the compression apparatus, this can still represent an appreciable efficiency saving in a typical thermal power plant. Typical energy consumption figures are given on FIGS. 1 and 2 for example illustrative purposes.

However, in a system such as illustrated in FIG. 2 only some of the thermal energy required to drive the reboiler is provided by the vapour recompression process. By way of example illustration only, possible thermal energy contributions are suggested on the figure. On the basis of the example figures given, only 64 MWth of the 192 MWth energy input required is provided. The system therefore still requires LP steam to provide the shortfall, albeit in reduced quantities.

An equivalent system including an example embodiment of the present invention, which reduces and potentially eliminates entirely the need for supply of LP steam from the LP turbine system, is illustrated schematically in FIG. 3.

The absorption apparatus upstream of the regeneration column is not pertinent to the invention, may be conventional, and may be the same as that in FIGS. 1 and 2 and like reference numerals are used where applicable.

The invention is distinguished in the sources of energy used to drive the heating means. Two sources are envisaged in accordance with the embodiment illustrated in FIG. 3.

The first source of thermal energy is provided by vapour recompression. Vapour produced by the regeneration process and drawn off from the top of the regeneration column is passed through successive compressors 33.

In the embodiment, the compressors are driven electrically, although use of an alternative drive means, for example including steam turbine drive means, could be considered without departing from the general principles of the invention.

Thermal energy from the compressed vapour is recovered to provide part of the thermal input required by the condenser reboiler 36. The compressed vapour is passed through a condenser to remove solvent, which is returned to the regeneration column 20, and the resultant CO₂ rich gas processed by further compression and dehydration 40 in the usual way. To that extent, the general principles of use of vapour recompression are similar to those embodied in FIG. 2.

The second source of thermal energy, by means of which the additional heat requirement of the condenser reboiler is supplied, particularly characterises the apparatus of FIG. 3. Instead of making up the shortfall with LP steam, energy is supplied via a heat pump, which is electrically driven, and recovers low grade heat energy from various sources. In the embodiment, suggested sources of low grade energy are the condenser and compression systems above described, and additionally a solvent cooling system provided in a solvent delivery conduit which delivers regenerated lean solvent from the condenser reboiler to the absorption column. Other sources of low grade heat might be considered without departing from the principles of the invention, for example recovered from the thermal power plant itself and/or from entirely secondary industrial plant.

These sources supply heat to a heat pump system based on vapour compression principles. Heat from every suitably available low grade heat source is passed to the LP vaporiser 48 and vaporises circulating thermodynamic fluid. The thermodynamic working fluid is suitably matched to the temperature range with appropriate properties. The vapour is compressed by the electrically driven compressor 46, and the vapour stream at suitable conditions is delivered to the reboiler 36 as a secondary source of thermal energy supplementary to that from the CO₂ vapour recompression system and instead of the residual LP steam required in the embodiment of FIG. 2.

The concept envisages using electrical power to drive the heat pump, and in the preferred case also to drive the vapour recompression process.

Application of the heat pump assumes thermal integration of the low grade heat streams from, in the embodiment, solvent cooling, CO₂ compression and condensation to deliver the required low grade heat for evaporation of suitable thermodynamic fluid in the vaporiser. The illustrated embodiment makes the PCC system entirely independent from the steam turbine cycle of the associated thermal power plant, and so obviates any heat/mechanical integration issues. The steam and electrical processes are kept entirely separate. This offers potential advantages in simplifying the process for a user.

1. An apparatus for the regeneration of a capture medium rich in a captured target gas and the recovery of captured gas therefrom comprising:
a containment structure defining a process volume;
a supply conduit to pass gas rich capture medium into the process volume;
condensing heating means fluidly connected to the process volume to heat the gas rich capture medium and thereby cause captured gas to dissociate into a gas rich vapour phase;
a vapour recompression system fluidly connected to the process volume to receive vapour output from the process volume and to compress the same;
a compressed vapour supply conduit to supply output compressed vapour to the heating means as a source of thermal energy therefor;
a secondary source of thermal energy for the heating means comprising a heat pump fluidly in communication with one or more sources of low grade heat so as to be driven in use to recover thermal energy from the source(s) of low grade heat and to supply the recovered thermal energy to the heating means as a further source of energy therefor.

2. An apparatus in accordance with claim 1 wherein the low grade heat source comprises a source of low grade heat recovered from a target gas absorption and regeneration process making use of the regeneration apparatus.

3. An apparatus in accordance with claim 2 wherein the low grade heat source comprises a source selected from compressors, condensers or other coolers within the process stream of a target gas absorption and regeneration process making use of a regeneration apparatus of the invention.

4. An apparatus in accordance with claim 1 wherein the heat pump is driven from a source of electrical power

5. An apparatus in accordance with claim 1 wherein the heat pump comprises a vapour-compression heat pump comprising means for the cyclical evaporation, compression and condensation of a circulating thermodynamic fluid.

6. An apparatus in accordance with claim 1 wherein the heating means is adapted to subject the captured gas rich capture medium to a repeatedly cycled heating.

7. An apparatus in accordance with claim 6 wherein the heating means is a condensing reboiler.

8. An apparatus in accordance with claim 1 wherein the heating means is not supplied with LP steam.

9. An apparatus in accordance with claim 1 wherein the supply of energy to the heating means consists solely of, in combination, the heat recovered by the vapour recompression system and the heat recovered by the heat pump.

10. An apparatus in accordance with claim 1 wherein the vapour recompression apparatus comprises a plurality of compressors in series.

11. An apparatus in accordance with claim 1 wherein the vapour recompression apparatus is adapted to compress the vapour to a pressure of 2 to 20 bar.

12. An apparatus in accordance with claim 1 further comprising a condenser to condense and recover capture medium vapour from the compressed vapour phase.

13. An apparatus in accordance with claim 1 further comprising a condenser to condense and recover water vapour from the vapour phase.

14. An apparatus in accordance with claim 1 further comprising fluidly in series a conduit to deliver the gas phase produced by the condensing heating means via condensing cooling means and a dehydration apparatus to a compression system for storage.

15. An apparatus in accordance with claim 1 adapted for use with an absorption apparatus suitable for absorbing a target gas from a source gas stream into a suitable capture medium, producing a target gas rich capture medium which may then be passed to the regeneration apparatus for regeneration of capture medium and recovery of absorbed target gas therefrom.

16. An apparatus for removal of a target gas from a source gas stream comprises an absorption apparatus fluidly upstream of a regeneration apparatus in accordance with claim 1.

17. An apparatus in accordance with claim 16 wherein the absorption apparatus comprises a means to absorb a target gas from a source gas stream into a suitable capture medium.

18. An apparatus in accordance with claim 17 wherein the absorption apparatus comprises a means to countercurrently flow an absorption solution and a source gas stream so as to cause the target gas to pass into and be absorbed by the absorption solution.

19. An apparatus in accordance with claim 16 wherein the source gas stream is flue gas from a combustion apparatus for the burning of carbonaceous fuels, such as flue gas from a thermal power plant.

20. A thermal power plant comprising a combustion means to burn carbonaceous fuel and generate steam provided a thermal power plant comprising a combustion means to burn carbonaceous fuel and generate steam, and a regeneration apparatus in accordance with claim 1 and a gas removal apparatus in accordance with claim 16.

21. A thermal power plant in accordance with claim 20 comprising a gas removal apparatus in accordance with claim 16 and a flue gas outlet fluidly connected to supply flue gas directly from the combustion apparatus as a source gas stream to the removal apparatus.

22. A method of regeneration of capture medium rich in a captured target gas and recovery of captured gas therefrom comprising the steps of:
heating a target gas rich capture medium and thereby causing captured gas to dissociate into a gas rich vapour phase;
compressing the vapour phase and using the compressed vapour as a first source of thermal energy for heating the capture medium;
additionally providing at least one supply of low grade heat to a heat pump and using the heat pump output as a further source of thermal energy for heating the capture medium.

23. A method in accordance with claim 22 comprising passing the gas rich capture medium through a regeneration apparatus in accordance with claim 1 having a heating means to heat the gas rich capture medium and thereby cause captured gas to dissociate into a gas rich vapour phase;
wherein the compressed vapour is used to supply thermal energy to the heating means; and
wherein the resultant heat pump output is used by the heating means as a further source of thermal energy therefor.

24. A method in accordance with claim 23 wherein the compressed vapour and the resultant heat pump output together consist essentially of the sole source of thermal energy for the heating means.

25. A method for the removal and recovery of a target gas from a gas stream which comprises the steps of:
capturing a target gas from a source gas stream into a suitable capture medium by passing the source gas stream through lean capture medium so as to cause a target gas component of the gas stream to associate with the capture medium drawing off the resultant target gas rich capture medium; processing the target gas rich capture medium in accordance with the method of claim 22.

26. A method of removal and recovery for sequestration of CO2 from a flue gas stream such as a thermal power plant flue gas stream comprising the method of claim 25 performed on a source gas stream comprising such a flue gas stream.

27. A method in accordance with claim 22 wherein the step of providing at least one supply of low grade heat to a heat pump comprises the supply of low grade heat from a source selected from one or more compressors, condensers or other coolers within the process stream of the method of the invention.
